(19) United States
(12) Patent Application Publication
(10) Pub. No.: US 2008/0019663 A1
(43) Pub. Date: Jan. 24, 2008

(54) Video Recording Device and Video Recording Method

(76) Inventor: Hiroyuki Marumori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/688,645

(22) Filed: Mar. 20, 2007

(30) Foreign Application Priority Data
Jul. 18, 2006 (JP) 2006-195384

(51) Int. Cl. H04N 7/00

(52) U.S. Cl. 386/53; 386/124; 386/E05.001

(57) ABSTRACT

The present invention realizes a special playback function such as a fade function or a sorted shooting function in a BD camera, and efficiently manages the management information. A file is produced according to a format based on a BDMV subset (BDMV-s) standard that is so defined as to arrange the respective directories of PLAYLIST, CLIPINFO, and STREAM below a BDMV directory which is arranged below a Root directory. One Play Item is produced in each of segmentations of the scene of an acquired video, a plurality of Play Items are arranged in one Play List, and management information for managing the special playback function is stored in an unallocated area of the Play Item.

### CLAIM OF PRIORITY

The present application claims priority from Japanese application serial No. JP 2006-195384, filed on Jul. 18, 2006, the content of which is hereby incorporated by reference into this application.

### BACKGROUND OF THE INVENTION

(1) Field of the Invention

The present invention relates to video recording devices and video recording methods, and more particularly to the management of a special playback function such as a fade function in a digital camera which records video information.

(2) Description of the Related Art

A fade function is realized by a video camera using a DVD as a recording medium. The fade function is a playback function that controls the connection of the video, a fade-in function that gradually displays the video, and a fade-out function that gradually fades away the video. As methods that gradually display the video, there are patterns such as a wipe-in that clips the video from a horizontal direction or a vertical direction, and gradually increases the pixel density from a screen of solid plain (for example, white or black) to display the video. As methods of gradually fading away the video, there are patterns such as wipe out that closes in the horizon direction or in the vertical direction, and dissolve out that gradually decreases the pixel density to make the screen solid (for example, white or black). A technique of controlling the fade-in function in a video camera has been disclosed in, for example, Japanese Patent Application Laid-Open No. H11-112868.

Also, a technique of managing a directory in a digital camera has been known in, for example, Japanese Patent Application Laid-Open No. 2004-304619. In the technique, in the case where a digital video data is stored in a memory card and managed, a folder in which video data is stored is newly produced within a memory card, and the video data is managed by the aid of an icon representative of the folder.

Incidentally, as one of the standards of the optical disc which bears the next generation of the DVD, the standard Blu-ray disc (BD) is defined. As the BD drive based on the BD standard, BD-ROM or BD-R has been put into practical use. Also, as the standard of the digital video camera that is capable of recording or playing back the digital high definition (HD) video with high precision by the aid of the DVD disc, an AVCHD (advanced video codec HD) is instituted.

The AVCHD/BD video camera that applies both of the BD and AVCHD standards records the shot video information on the recording medium as a file in the format of the application based on the BD-RE Ver 3.0 standard. The standard is a subset (BDMV subset, hereafter referred to as “BDMV-s”) of the BDMV format based on the BD-ROM standard, and a format that defined the self encode time of a recorder or a camera, which manages one recording unit by Play List.

### SUMMARY OF THE INVENTION

With the practical application of the BD camera, there is a demand to realize the fade function that has been realized by the DVD camera up to now by a BD camera. The digital camera is characterized in that the fade can be set with respect to a favorite scene after the video has been shot. However, even though the function that has been realized by the DVD camera is going to be realized by the BD camera as it is, the immediate realization is disenabled because the DVD camera and the BD camera are completely different from each other in the mechanism of the management information. For example, it is necessary to manage the fade function in each of thumbnails, but the BD camera suffers from such a problem that where and how the fade information is stored in each of the scenes.

Also, as the method of managing the directory, a sorted shooting function is realized in the recent video recorder. The sorted shooting function separates the storing positions and directories of the broadcasted video on the basis of data broadcast information. It may be useful to separate and manage the directories in each of categories such as a travel or athletic meet at which opportunities for using the camera are relatively much. However, in the field of the digital camera, the sorted shooting function has not yet been realized.

Even if the special playback functions are merely realized by the BD camera, a device is required to efficiently manage the management information of those functions. This is because it is necessary to read the management information in an internal memory when the BD camera starts, but when the management information is stored at an irregular location or a location that violates the standard, not only the use efficiency of the memory is deteriorated, but also it takes time to read the video file or the management information.

The present invention has been made under the above circumstances, and therefore an object of the present invention is to provide a BD camera that realizes a special playback function such as the fade function or the sorted shooting function, a video recording device, a video recording method, and a recording medium that has been subjected to a given format which is used for the BD camera and the video recording device and method.

Another object of the present invention is to manage management information of the special playback function by using a memory efficiently.

Still another object of the present invention is to prevent a period of time for reading the management information in the memory from being prolonged even if the number of scenes of the video to be recorded is increased.

According to the present invention, there is provided a video recording method, preferably, a video recording method that records video on a recording medium in a given file format, including: setting management information for managing a special playback function in correspondence with a given recording unit for recording the video; storing the management information in the memory; and recording the video on the recording medium.

In a preferable example, the special playback function includes a fade function which displays a setting statue of the fade function together when a thumbnail screen is displayed on a display section.

Also, it is preferable that video information of the record unit is read on the memory together with the management information.

Also, it is preferable that the video is recorded on the recording medium in each of the scenes, the management information is set in each of the scenes, and the management information is read in the memory in each of the scenes while the management information is read in the memory.

Also, it is preferable that one Play Item is produced in each of scene segmentations of the acquired video, a plurality of Play Items are arranged in one Play List, and the management information is set in an unallocated area of the Play Item and stored in the memory.

Also, it is preferable that the management information is set by the aid of plural bits within 11 bits reserved for use as an unoccupied area within the Play Item. Also, it is preferable that when the video is produced from the recording medium on which the video has been recorded through the above method, the video is played back on the basis of the special playback function with reference to the management information.

Also, in a preferable example, there is provided a video recording method that records a video on a recording medium in a file format, including: arranging a BDMV directory below a Root directory; producing a file according to a format based on a BDMV subset (BDMV-s) standard that is so defined as to arrange the respective directories of PLAYLIST, CLIPINFO, and STREAM below the BDMV directory; producing one Play Item in each of segmentations of the scene of an acquired video; arranging a plurality of Play Items in one Play List; storing management information for managing a special playback function in unallocated area within the Play Item; and recording the video on the recording medium according to the format.

It is preferable that the Play Item is increased one by one and produced without updating the Play List every time the video of one scene is recorded on the recording medium.

Also, it is preferable that the Play List is newly produced and updated every time date is updated.

Also, it is preferable that in one video record, a file of mpls, a file of clpi, and a file of m2ts are managed as one set, and the file of mpls is associated with the Play Item, and information for managing locations of a start and an end at which the video is recorded in the Play Item is stored.

According to the present invention, there is provided a video recording device, preferably, a video recording device that records a video on a recording medium in a file format, including: an operating section that is operated for setting a special playback function; a special playback function control section that sets the special producing function with respect to the video of a given recording unit, which is designated by the operation section; and a memory that stores management information for managing the set special playback function in correspondence with a given recording unit that records the video.

Also, according to the present invention, there is provided a recording medium that records the video in a given file format; which arranges a BDMV directory below a Root directory; produces a file according to a format based on a BDMV subset (BDMV-s) standard that is so defined as to arrange the respective directories of PLAYLIST, CLIPINFO, and STREAM below the BDMV directory; produces one Play Item in each of segmentations of the scene of an acquired video, arranges a plurality of Play Items in one Play List; and records the image that is managed according to management information for setting a special playback function, which is stored in an unallocated area within a Play Item, according to a given format.

According to the present invention, the special playback function such as the fade function or the sorted shooting function can be realized in the BD camera, and the management information can be efficiently managed. Also, the management information can be managed by efficiently using the memory, and even if the number of recorded video scenes is increased, it is unnecessary to read the Play List in each case, it does not take a long time to read the video file or the management information.

### BRIEF DESCRIPTION OF THE DRAWINGS

Embodiment of the present invention will be described in detail based on the following figures, wherein:

FIG. 1 is a block diagram showing the configuration of BD camera according to an embodiment of the present invention;

FIG. 2 is a diagram showing the data configuration of a subset of a BDMV format;

FIGS. 3A and 3B are diagrams showing the structural configuration of Play List;

FIG. 4 is a diagram showing an example of a thumbnail of a BD camera; and

FIGS. 5A to 5D are diagrams showing the structural example of the management information of a special playback function of the BD camera.

### DETAILED DESCRIPTION OF THE EMBODIMENT

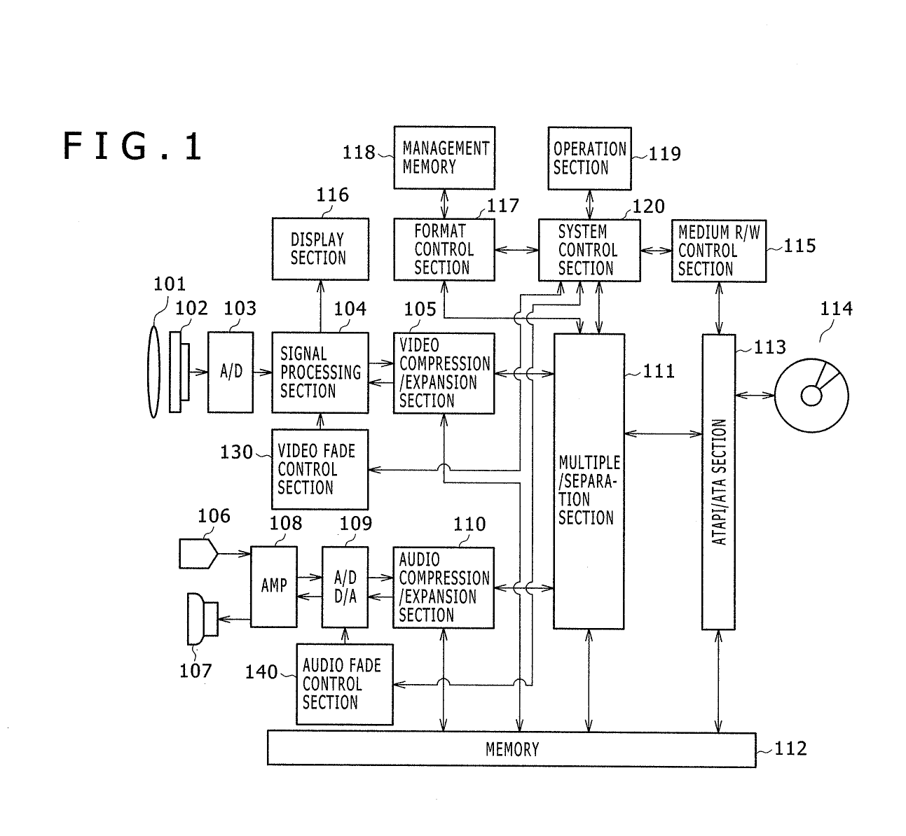

Now, a description will be given in more detail of preferred embodiments of the present invention with reference to the accompanying drawings. First, a description will be given of BD-RE Ver3.0 that is the standard applied to a BD camera according to this embodiment. FIG. 1 is a diagram showing the data structure of a subset (BDMV-s) of a BDMV format. The BDMV format is a format of the application defined by standard BD-RE Ver 3.0 which is based on BD-ROM standard. As the format assuming record at the time of self encode of a record or camera, one record unit is managed by Play List. That is, a BDMV directory is arranged below a Root directory, and the respective directories of PLAYLIST, CLIPINFO, and STREAM are arranged below the BDMV directory. The respective directories of PLAYLIST, CLIPINFO, and STREAM are recorded as a set (pair) by each record. For example, a file of 00000.mpls, a file of 01000.clpi, and a file of 01000.m2ts are recorded by a first record. A file of 00001.mpls, a file of 02000.clpi, and a file of 02000.m2ts are recorded by a second record. In this way, the files are sequentially increased every record. In the general products of the digital camera, the maximum value of the scene is set to 1000. For that reason, it is desirable that the upper limit of the number of sets of the above file is about 1000. An extension of mpls, clpi, m2ts can be also called a file of mpls.

Incidentally, in general, the recorder suffers from no problem since the number of recordings is not so large. However, the camera is different from the recorder, and frequently takes a large number of short scenes. In the BD camera, an mpls file, a clpi file, and an m2ts file are added to management information as one set and stored every time the video is recorded once. That is, the number of files is increased every time the video is recorded. On the other hand, when the BD camera starts, it is necessary to read the mpls file in a memory. For that reason, when the number of recorded videos is increased, a period of time required for the file reading is prolonged, and a starting time is also prolonged, which is a problem.

Accordingly, in this embodiment, in order to shorten the starting time, it is considered so as to reduce the number of video files as large as possible. That is, as one of the features, a plurality of Play Items are defined in one Play List and managed. The Play Item manages the information of the mpls file that manages locations of a start and an end of a video to be recorded, and the management information corresponds to the video of one scene. In the case of the BD camera in this embodiment, it is preferable that the format is formed so as to hold 2000 Play Lists at maximum and 999 Play Items at maximum per one Play List, taking the circumstances into account.

Further, as one of the features, the management information of the fade function or the sorted shooting function (hereinafter referred to as “special playback function”) is stored in an unallocated area of one Play Item, to thereby make the memory efficient. Also, as one of the features, a process for reading the management information of the special playback function that is saved in the unallocated area of the Play Item is conducted together with the reading of the respective corresponding scenes (Play Item). As a result, it is possible to increase a speed of a process for reading the mpls filer or the management information at the time of starting the BD camera.

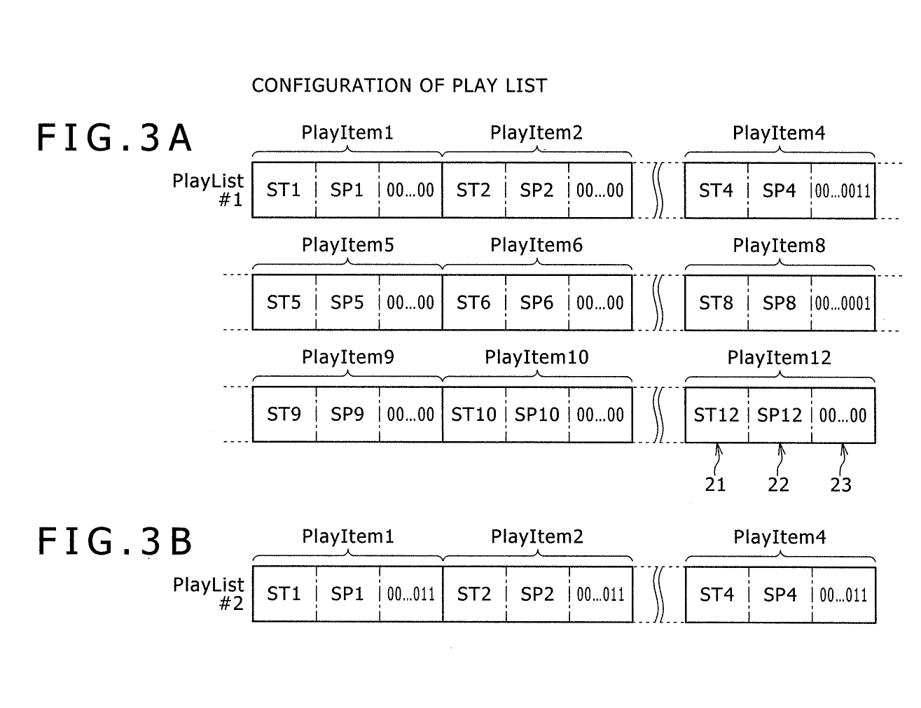

FIGS. 3A and 3B show structural examples of the Play List. This example shows that plural Play Lists #1 and #2, and plural Play Items that are formed within each of the Play Lists are managed. It is preferable that one Play List is newly produced and added as the management information on a date when shoot is made with a change in date. The date information quotes the date and time information that is timed by the clock mechanism of the system control section 120 (see FIG. 1). That is, the Play Item is added to the newly produced Play List every time one scene of the video which has been shot on the same date is increased. Then, the Play Item corresponding to the mpls file, the clpi file, and the m2ts file are produced as one set and managed in each of the video scene records. In the example shown in the figure, the Play List #1 is a first day, for example, Jul. 7, 2006, and the Play List #2 is another day that is different from the first day.

The Play Item corresponds to the video of one scene, and stores the information of the mpls file which manages locations of a start and an end of the recorded video. That is, every time the video of one scene is recorded on the recording medium, a start (ST) 21 and an end (SP) 22 corresponding to the scene, as well as the management information 23 of the special playback function are produced, and stored in the memory to manage the video file.

The start 21 and the end 22 are the information of the mpls file, and managed by using a range of 25 bytes according to the BDMV-s standard. As the information of the start and the end, an address on the optical disc on which the video is recorded can be used. Alternatively, it is possible that the date and time information that is timed by the clock mechanism can be stored as a time stamp, to thereby manage the storage location of the video.

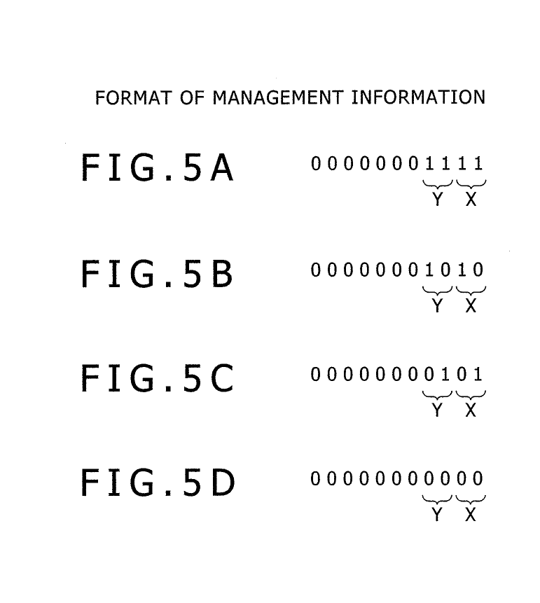

The management information 23 of the special playback function uses 11 bits of the unallocated area of the Play Item, for example, the reserve area (reversed for use). For example, as shown in FIGS. 5A to 5D, the presence/absence of the fade function is managed by two lower bits (X portion) in 11 bits, and the sorted shooting function is managed by the subsequent two bits (Y portion). The remaining bits are provided for another management. In the two bits of the fade function X, one lowest bit represents the presence/absence of the fade-in function, and the second lower bit represents the presence/absence of the fade-out function. Accordingly, in the case where the fade management information is “11”, the fade-in and the fade-out are present, and in the case where the fade management information is “01”, the fade-in is present and the fade-out is absent. In the case where the fade management information is “01”, the fade-in is absent, and the fade-out is present, and in the case of “00”, both of those functions are absent.

Also, four kinds of categories can be categorized by two bits of the sorted shooting function Y. For example, two bits of the Y portion are associated with “11” travel, “10” school event of children, “01” piano class, and “00” family, thereby enabling the respective Play Items to be classified to four kinds of directories. The bits of the Y portion are further increased so as to increase the number of classified directories. The bits of the Y portion are further increased, thereby enabling the number of classified directories to be increased. On the contrary, in the case where the sorted shooting function is unnecessary, it is possible that no bits of the Y portion are provided, or the state of “00” is defined without the sorted shooting function.

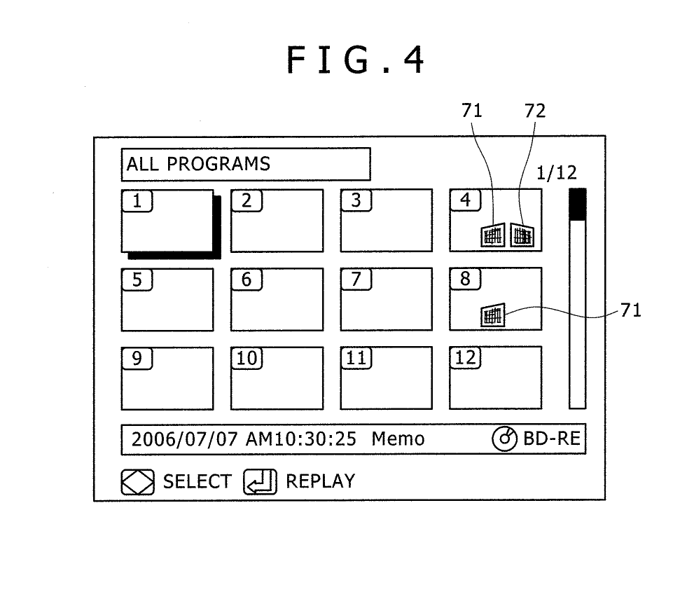

An example of the thumbnail screen of the BD camera will be described with reference to FIG. 4. The number of thumbnails that are displayed on a screen is 12 in total, an icon 71 indicates the fade-in, and an icon 72 indicates the fade-out. A user operates an operating section 119, and sets the fade-in 71 and the fade-out 72 with respect to the video of the scene that should be faded. In the example shown in the figure, the fade-in 71 and the fade-out 72 are set in the fourth scene, and only the fade-in 71 is set in the eighth scene.

Returning to FIGS. 3A and 3B, a description will be made in more detail. The setting of the management information 23 of the fade function related to the Play Item of the Play List #1 shown in FIG. 3A is associated with the fade function of the thumbnail screen shown in FIG. 4. Therefore, the management information 23 of the fade function X of the fourth scene is “00..0011” since both of the fade-in and the fade-out are present. Also, the management information 23 of the fade function X of the eighth scene is “00..0001” since the fade-in is present and the fade-out is absent. The management function 23 of the fade function X of other scenes is “00..000” since all of the fade-in and the fade-out are absent. Since all of the Y portions are “00” in the management information 23, the video of this example is managed by the directory of “family”. Also, as shown in FIG. 3B, the management information 23 of the fade function related to the Play Item of the Play List #2 is the video of another date, and the sorted shooting function Y is “11”, and indicative of “travel”. Since the fade function X is “11”, “presence” is set in both of the fade-in and the fade-out.

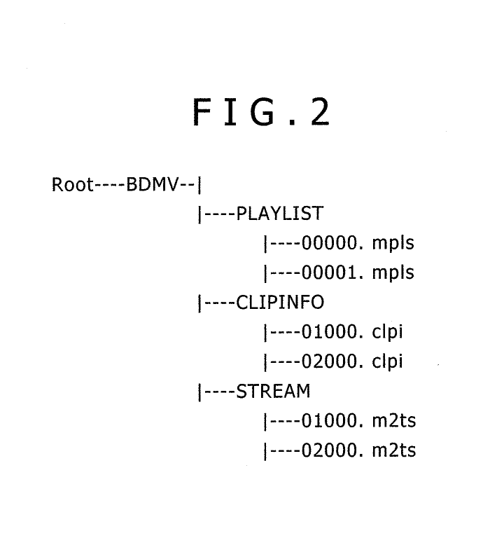

As described above, the management file and the management information 23 which are defined according to the description of FIGS. 2, 3A and 3B, and set according to the management format is produced, stored in the management memory 118, and managed every time the video is recorded by the format control section 117 of FIG. 1 as will be described later. Also, when the video is played back, the management information that has been stored in the memory 118 is displayed.

Subsequently, the configuration of the BD camera will be described with reference to FIG. 1. Referring to FIG. 1, reference numeral 101 denotes an optical lens for imaging an object, 102 is a CCD sensor that is photoelectric conversion means for converting an imaged light into an electric signal, 103 is an A/D converter that converts the video electric signal into a digital signal, 104 is a signal processing section that conducts processing for converting the video information that has been converted into the digital signal into a video signal, and 105 is a video compression/expansion section that compresses and expands the video signal according to a given encoding system such as MPEG. Reference numeral 130 denotes a video fade control section that sets the fade function of the fade-in or the fade-out by the aid of icons with respect to the video that has been recorded on the recording medium 114 according to a designation from the operating section 119.

Also, reference numeral 106 denotes a microphone that converts a collected sound into an electric audio signal, 107 is a speaker that generates a sound, 108 is an amplifier that amplifies the audio signal, 109 is an A/D converter (D/A converter) that converts the audio electric signal into a digital signal, and 110 is an audio compression/expansion section that compresses and expands the digital audio according to a given encoding system such as JPEG. Reference numeral 140 denotes an audio fade control section that sets the fade function such as the fade-in or the fade-out by the voice with respect to the video that has been recorded on the recording medium 114 according to the designation from the operating section 119.

Reference numeral 111 denotes a multiplex section that multiplexes a moving picture compression stream that has been generated by the video compression/expansion section 105 and an audio compression stream that has been generated by the audio compression/expansion section 110, and 112 is a large-capacity memory that temporarily stores video data that has been compressed by the video compression/expansion section 105, audio data that has been compressed by the audio compression/expansion section 110, and data resulting from multiplexing the video data and the audio data. Also, an ATAPI/ATA section 113 is an interface section that complies with a specific standard, and 114 is a recording medium such as an optical disc. A medium R/W control section 115 conducts control for recording and playing back data file of a video to be recorded and played back with respect to the recording medium 114 in a given file format.

Reference numeral 116 denotes a display section that displays the video. The display section 116 can be separated into a display section within a finder, and a movable display section that is disposed outside of a casing of a video camera. Reference numeral 117 denotes a format control section that identifies the type of the recording medium to generate the information on the format that complies with the BDMV-s standard, and 118 is a management memory that stores the recording format of the data file which is recorded on the recording medium and management information for recording and playback. Reference numeral 119 denotes an operating section that is operated by a user, which includes a record/stop key, a zoom key, a select key of a record mode, and a command key of a fade function. Reference numeral 120 denotes a system control section that controls the respective sections of the multiplex/separation section 111, the format control section 117, and the medium R/W control section 115. The system control section 120 has a clock mechanism that times year, month, date, hour, and minute (hereinafter, simply called “date and time”). The date and time that are timed by a clock mechanism are recorded on the stream at the time of multiplexing, and also recorded on the recording medium 114.

In this example, the respective functions of the video compression/expansion section 105, the audio compression/expansion section 110, the multiplex/separation section 111, the format control section 117, the video fade control section 130, the audio fade control section 140, and the system control section 120 are preferably realized by executing micro programs by the aid of a microprocessor. However, a part or all of those programs can be configured by hardware. Also, in FIG. 1, control lines and information lines which are necessary for description are shown, and all of the control lines and the information lines in a product are not always shown. In fact, all of the structural units are substantially connected to each other.

Subsequently, the moving picture recording operation will be described. In the case where the moving picture shooting mode is selected by the operation of the operating section 119, the system control section 120 recognizes the selection, and controls the overall system as follows. The CCD sensor 102 is driven to a moving picture signal generating mode by a drive section (not shown). The image formed by the optical lens 101 is converted into the electric signal by the CCD sensor 102, and then converted into the digital signal by the A/D converter 103. Thereafter, the image is converted into the video data by the signal processing section 104, and temporarily stored in the memory 112. Thereafter, the video data is compressed by the video compression/expansion section 105, and in the compressing process, the video data is sequentially converted into the moving picture compression stream while the video data that is being compressed is transferred between the memory 112 and the video compression/expansion section 105. On the other hand, the sound that has been collected by the microphone 110 is compressed by the audio compression/expansion section 110, and then temporarily stored in the memory 112, likewise. Thereafter, the moving picture compression stream that has been generated by the video compression/expansion section 105 and the audio compression stream that has been generated by the audio compression/expansion section 110, which are stored in the memory 112, are multiplexed by the multiplex/separation section 111, and the multiplexed data is temporarily stored in the memory 112. Finally, the multiplexed data is output from the memory 112, and then recorded on the recording medium 114 in the given recording format through the medium R/W control section 115 and the ATAPI/ATA section 113. The recording format is characterized by this embodiment, and the format control section 117 manages the recording format by a predetermined format, and the shot video is recorded on the recording medium every video scene, as will be described later with reference to FIGS. 2, 3A and 3B.

Subsequently, the video playback operation will be described. The video is recorded on the recording medium 114 in the file format shown in FIGS. 2, 3A and 3Bs. When the video playback mode is selected by the operating section 119, the overall system is controlled by means of the system control section 120 as follows, and the video in each of scenes is read from the recording medium 114, and played back in the format that is managed by the format control section 117. That is, the medium R/W control section 115 plays back the video file, and the multiplex/separation section 111 separates the video file into a video compression stream and an audio compression stream, and transmits the video compression stream to the video compression/expansion section 105. The video compression/expansion section 105 sequentially converts the video compression stream into the video signals while transferring the video data that is being expanded with respect to the memory 112. The video compression/expansion section 105 then outputs the video signals to the display section 116 through the signal processing section 104. The audio compression/expansion section 110 expands the audio compression stream, and outputs the expanded stream from the speaker 107.

Subsequently, the setting of the fade function will be described. The shot video information has been already recorded on the recording medium 114. Under the circumstances, the operator operates the operating section 119 to display the thumbnail screen on the display section 116. Then, the operator designates the video scene to designate the fade-in or the fade-out. For example, as shown in FIG. 4, when the operator designates the fade-in or the fade-out in a fourth scene, and designates only the fade-in in an eighth scene, the system control section 120 recognizes the designation from the operating section 119, and controls the video fade control section 130 and the audio fade control section 140. Then, the video fade control section 130 and the audio fade control section 140 set the fade function in the fourth and eighth scenes that have been designated, respectively. That is, as shown in FIGS. 3A and 3B, the X bits of the management information corresponding to the subject Play Items 4 and 8 are set. The management information thus set is held in the unallocated area of the Play Item, and stored in the management memory 118.

Subsequently, the setting of the sorted shooting function will be described. The control section for setting the sorted shooting function is not shown in FIG. 1. However, it is assumed that the video fade control section 130 and the audio fade control section 140 are replaced with a video sorted shooting control section 130′ and a video sorted shooting function 140′, and those control sections control the setting of the sorted shooting function.

As with the designation of the fade function, the operator operates the operating section 119 to display the thumbnail screen on the display section 116. Under the circumstances, the operator designates the video scene, and designates the sorted shooting. When it is assumed that four kinds of categories of “11” travel, “10” school event of children, “01” piano class, and “00” family are predetermined as the sorted shooting function, the operator selects one category from those four kinds of categories, and then designates the category in each of the scenes.

For example, when “travel” is selected with respect to all of 12 scenes shown in FIG. 4, the system control section 120 recognizes the designation from the operation section 119, and controls the video sorted shooting sections 130′ and the audio sorted shooting control section 140′. As a result, those control sections 130′ and 140′ set the sorted shooting function of “travel” with respect to all of the scenes, that is, set “11” in the management information Y bit.

According to the modified example of the present invention, the special playback function is not limited to the above fade function or sorted shooting function. For example, in the case of realizing the wipe-in/wipe-out function which closes or opens the screen from the vertical direction of the displayed image with respect to the center portion, the same setting can be executed by the aid of the above management information.

What is claimed is:

1. A video recording method that records a video on a recording medium in a given file format, comprising the steps of:
setting management information for managing a special playback function in correspondence with a given recording unit for recording the video;
storing the management information in the memory; and
recording the video on the recording medium.

2. The video recording method according to claim 1, further comprising the steps of:
including a fade function as the special playback function; and
displaying a setting statue of the fade function together when a thumbnail screen is displayed on a display section.

3. The video recording method according to claim 1, further comprising the step of:
reading video information of the record unit on the memory together with the management information.

4. The video recording method according to claim 1, further comprising the steps of:
recording the video on the recording medium in each of the scenes;
setting the management information in each of the scenes; and
reading video information of the record unit in the memory in each of the scene while the management information is read in the memory.

5. The video recording method according to claim 1, further comprising the steps of:
producing one Play Item in each of scene segmentations of the acquired video;
arranging a plurality of Play Items in one Play List; and
setting the management information in an unallocated area of the Play Item and storing in the memory.

6. The video recording method according to claim 5, further comprising the step of:
setting the management information by the aid of a plurality of bits within 11 bits reserved for use as an unoccupied area within the Play Item.

7. A video playback method that plays back a video from the recording medium on which the video has been recorded according to the method of claim 1, comprising the step of:
playing back the video on the basis of the special playback function with reference to the management information.

8. A video recording method that records a video on a recording medium in a given file format, comprising the steps of:
arranging a BDMV directory below a Root directory;
producing a file according to a format based on a BDMV subset (BDMV-s) standard that is so defined as to arrange the respective directories of PLAYLIST, CLIPINFO, and STREAM below the BDMV directory;
producing one Play Item in each of segmentations of the scene of an acquired video, and arranging a plurality of Play Items in one Play List;
storing management information for managing a special playback function in unallocated area within the Play Item; and
recording the video on the recording medium according to the format.

9. The video recording method according to claim 8, further comprising the step of:
increasing the Play Item one by one and producing without updating the Play List every time when the video of one scene is recorded on the recording medium.

10. The video recording method according to claim 8, further comprising the step of:
newly producing and updating the Play List every time when date is updated.

11. The video recording method according to claim 8, further comprising the steps of:
managing, in one video record, a file of mpls, a file of clpi, and a file of m2ts as one set; and
storing information for managing locations of a start and an end at which the video is recorded in the Play Item of the file of mpls.

12. A video recording device that records a video on a recording medium in a file format, comprising:
an operating section that is operated for setting a special playback function;
a special playback function control section that sets the special producing function with respect to the video of a given recording unit, which is designated by the operation section; and
a memory that stores management information for managing the set special playback function in correspondence with a given recording unit that records the video.

13. The video recording device according to claim 12, further comprising:
a display section that includes a fade function as the special playback function, and displays the setting status of the fade function on the produced thumbnail screen.

14. The video recording device according to claim 12,
wherein video information of the record unit is read on the memory together with the management information.

15. The video recording device according to claim 12,
wherein one Play Item is produced in each of scene segmentations of the acquired video, a plurality of Play Items are arranged in one Play List, and the management information is set in an unallocated area of the Play Item and stored in the memory.

16. A recording medium that records the video in a given file format,
wherein a BDMV directory is arranged below a Root directory;
a file is produced according to a format based on a BDMV subset (BDMV-s) standard that is so defined as to arrange the respective directories of PLAYLIST, CLIPINFO, and STREAM below the BDMV directory;
one Play Item is produced in each of segmentations of the scene of an acquired video, and a plurality of Play Items are arranged in one Play List; and
the image that is managed according to management information for setting a special playback function, which is stored in an unallocated area within a Play Item, is recorded according to a given format.
